(19) United States
(12) Patent Application Publication
(10) Pub. No.: US 2006/0078481 A1
(43) Pub. Date: Apr. 13, 2006

(54) System and method for corrosive vapor reduction by ultraviolet light

(75) Inventors: Charles E. Venditti, Mechanicsville, VA (US); Christopher M. Devany, Mechanicsville, VA (US); Eric E. Thompson, Glen Allen, VA (US); Gary W. Skinner, Midlothian, VA (US); David A. Griffiths, Mechanicsville, VA (US)

Correspondence Address: BRINKS HOFER GILSON & LIONE, P.O. BOX 10395, CHICAGO, IL, 60610, US

(73) Assignee: Infineon Technologies Richmond LP

(21) Appl. No.: 10/963,400

(22) Filed: Oct. 12, 2004

(51) Int. Cl. A62D 3/00; B08B 3/12; C23G 1/00; B01J 19/12

(52) U.S. Cl. 422/186.3; 588/301; 134/1; 134/2

(57) ABSTRACT

A system and method for reducing out-gassing, i.e. discharge or emissions, of corrosive vapors/gasses, such as Hydrogen Bromide, Hydrogen Chloride and/or Hydrogen Fluoride, from semiconductor processing equipment and processed semi-conductor materials, into the surrounding environment is disclosed. Out-gassing is the release of gases from the surfaces of a solid body. In the disclosed system and method, after the requisite semiconductor processing has completed, a radiant energy source, such as an ultraviolet light source is exposes the corrosive gas or processed semiconductor materials, e.g. wafers, while the gas or materials are still contained within the processing equipment. The ultraviolet light energy decomposes the corrosive gas into lesser corrosive components thereof, i.e. disassociates the molecules of the corrosive gas. The disassociated species may then combine into volatile molecules that may be evacuated through the pumping system to an exhaust system. The processing equipment can then be opened releasing fewer corrosive components into the surrounding environment.

### BACKGROUND

Economical manufacturing of integrated circuits, such as microprocessors, requires mass production wherein several hundred dies, or circuit patterns, may be created on the surface of a silicon wafer simultaneously. Integrated circuits are typically constructed by a process of deposition and removal of conducting, insulating, and semi-conducting materials one thin layer at a time until, after hundreds of separate steps, a complex sandwich is constructed that contains all the interconnected circuitry of the integrated circuit. The silicon wafer and the thin films on top of the surface of the wafer are used for the electronic circuit. In one exemplary integrated circuit fabrication process, the processing steps include substrate creation and various combinations of oxidation, lithography, etching, ion implantation, and film deposition. The bulk of these steps are repeated over and over to build up the various layers of circuits. It will be appreciated that there are many different techniques for fabricating integrated circuits.

In the exemplary process, the first step in producing an integrated circuit is the creation of an ultrapure silicon substrate, a silicon slice in the shape of a round wafer that is polished to a mirror-like smoothness.

In the oxidation step, an electrically non-conducting layer, called a dielectric, is placed between each conductive layer on the wafer. One type of dielectric is silicon dioxide, which is “grown” by exposing the silicon wafer to oxygen in a furnace at about 1000° C. (about 1800° F.). The oxygen combines with the silicon to form a thin layer of oxide about 75 angstroms deep.

Nearly every layer that is deposited on the wafer must be patterned accurately into the shape of the transistors and other electronic elements. Usually this is done in a process known as photolithography, which is analogous to transforming the wafer into a piece of photographic film and projecting a picture of the circuit on it. A coating on the surface of the wafer, called the photoresist or resist, changes when exposed to light, making it easy to dissolve in a developing solution. These patterns may be as small as 0.25 microns or smaller in size. Because the shortest wavelength of visible light is about 0.5 microns, short-wavelength ultraviolet light may be used to resolve the tiny details of the patterns. After photolithography, the wafer is etched—that is, the resist is removed from the wafer either by chemicals, in a process known as wet etching, or by exposure to a corrosive gas, called a plasma, in a special vacuum chamber.

In the next step of the process, ion implantation, also called doping, impurities such as boron and phosphorus are introduced into the silicon to alter its conductivity. This is accomplished by ionizing the boron or phosphorus atoms (stripping off one or two electrons) and propelling them at the wafer with an ion implanter at very high energies. The ions become embedded in the surface of the wafer.

The thin layers used to build up an integrated circuit, such as a microprocessor, are referred to as films. In the final step of the process, the films are deposited using sputterers in which thin films are grown in a plasma; by means of evaporation, whereby the material is melted and then evaporated coating the wafer; or by means of chemical-vapor deposition, whereby the material condenses from a gas at low or atmospheric pressure. In each case, the film must be of high purity and thickness must be controlled within a small fraction of a micron.

Integrated circuit features are so small and precise that a single speck of dust can destroy an entire die. The rooms used for integrated circuit creation are called clean rooms because the air in them is extremely well filtered and virtually free of dust. The purest of today's clean rooms are referred to as class 1, indicating that there is no more than one speck of dust per cubic foot of air. (For comparison, a typical home is class one million or so.)

In order to accomplish the various manufacturing processes, many different chemicals are used, such as acids. These chemicals may be toxic to humans, corrosive to machinery, and/or generally hazardous. Further, the requirements for handling these chemicals may require additional processing steps or machinery adding to the necessary costs and resources. Accordingly, there is a need to contain and manage these hazardous chemicals to ensure a safe work environment, minimize additional costs and resources required to handle these chemicals, as well as minimize damage and/or premature wear to manufacturing systems.

### BRIEF DESCRIPTION OF THE DRAWINGS

FIG. 1 depicts a block diagram of an exemplary corrosive vapor reduction system according to one embodiment.

FIG. 2 is a flow chart depicting an exemplary process for reducing corrosive vapors according to the embodiment of FIG. 1.

### DETAILED DESCRIPTION OF THE DRAWINGS AND PRESENTLY PREFERRED EMBODIMENTS

A system and method for reducing out-gassing, i.e. discharge or emissions, of corrosive vapors/gasses, such as Hydrogen Bromide, Hydrogen Chloride and/or Hydrogen Fluoride, from semiconductor processing equipment and processed semi-conductor materials, into the surrounding environment and/or increasing the rate of desorption of the corrosive gases, is disclosed. Out-gassing is the release of gases from the surfaces of a solid body. In the disclosed system and method, after the requisite semiconductor processing has completed, a radiant energy source, such as an ultraviolet light source exposes the corrosive gas or processed semiconductor materials, e.g. wafers, while the gas or materials are still contained within the processing equipment. The ultraviolet light energy decomposes the corrosive gas into lesser corrosive components thereof, i.e. disassociates the molecules of the corrosive gas. The disassociated species may then combine into volatile molecules that may be evacuated through a pumping system to an exhaust system. The processing equipment can then be opened releasing fewer corrosive components into the surrounding environment and/or hazardous material handling or recovery systems.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

Prior methods and systems of dealing with corrosive gasses in a semiconductor processing environment include: doing nothing and tolerating the increase safety, maintenance and cost requirements; performing a water rinse of the processed materials and/or equipment to remove the corrosive gas; or introducing a side storage laminar flow process whereby the processed semiconductor materials may be stored while the corrosive gasses are permitted to naturally vent in a controlled environment. As can be seen, the prior methods either ignored the problem and simply dealt with the effects thereof, or introduced additional processing stages, along with attendant costs, manufacturing delays, etc.

The disclosed embodiments introduce a radiant energy source proximate to the contained corrosive gas or semiconductor materials which converts the gas into a lesser corrosive form which can be safely and effectively handled, either by release into the surrounding environment or by venting away, such as with an exhaust system. Introducing the radiant energy source may require minimal modifications to existing equipment and process flows.

Common chemicals used in semiconductor processing include inorganic acids, i.e. acids which have no hydrocarbons, such as Hydrogen Bromide (“HBr”), Hydrogen Chloride (“HCl”) or Hydrogen Fluoride (“HF”). These chemicals are also referred to as Hydrogen Halides, i.e. a halogen element, any of the five nonmetallic elements that comprise Group VIIa of the periodic table. The halogen elements are fluorine (F), chlorine (Cl), bromine (Br), iodine (I), and astatine (At). It will be appreciated that the disclosed embodiments may be utilized to convert any suitable chemical as described herein. These chemicals are commonly used in the etch processing of semiconductor wafers. To perform the etching process, the wafers are introduced into an etch chamber which is then sealed. The etching chemicals, such as those described above, are then introduced into the chamber. After the etching process is complete, the chamber is opened to remove and continue processing the wafers. At this time, the residual etching chemicals present in the processed semiconductor wafers may be released, i.e. out-gassed, to the surrounding environment as was described. For example, typically these corrosive gasses contaminate, i.e. are released near or on, the process devices which move the wafers around or the process devices which are used in subsequent wafer processing, causing premature corrosion, etc.

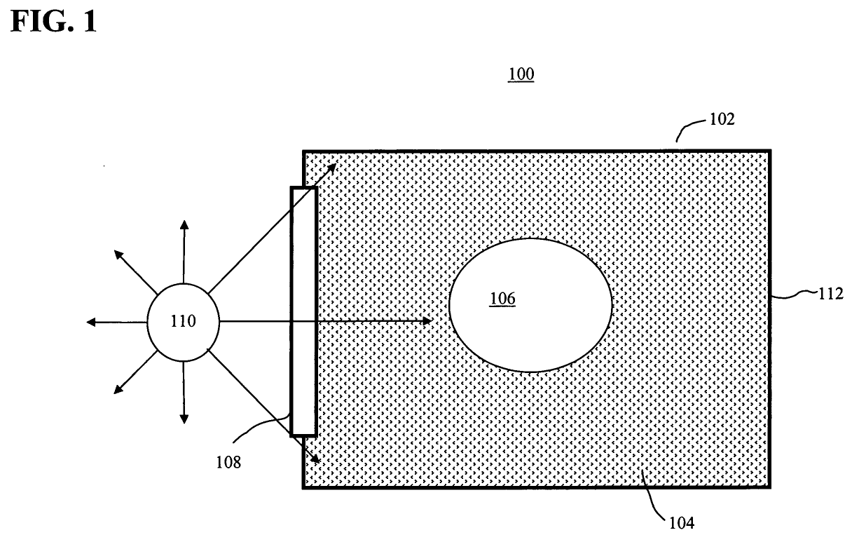

FIG. 1 shows a block diagram of an exemplary corrosive vapor reduction system 100 according to one embodiment. The system 100 includes a semiconductor manufacturing/processing device 102, such as a process chamber, a buffer/transfer chamber or a load lock. In one embodiment, the processing device 102 is a load lock which is used to load/unload wafers or other semiconductor materials 106 into other processing devices 102 in order to protect the environmental conditions therein. In an alternate embodiment, the processing device 102 is an etch chamber. The processing device 102 includes a housing 112 which, when closed, acts to contain corrosive gas emissions within the interior of the housing and prevent those gasses from escaping to the surrounding environment. Further, the processing device 102 features a door or other portal (not shown) which may be opened to access the interior of the processing device 102 housing 112 to load and unload semiconductor devices/materials 106, such as silicon wafers, for processing. During processing of semiconductor materials/devices 106, the semiconductor device/material 106 may be located within the processing device 102. If the semiconductor device/material 106 has undergone a process in which it was exposed to corrosive gasses, as described above, either in the current processing device 102 or in previous processing stage using a different processing device 102, there may be residual corrosive gas 104 within the processing device 102. This residual corrosive gas 104 may be present due out-gassing from the semiconductor materials/device 106 and/or may be left over from the prior processing stage.

The processing device 102 further features a radiant energy transmissive portion, such as a window 108, located in the housing 112. The transmissive portion 108 operates to allow radiant energy to pass into the interior of the processing device 102 without allowing the corrosive gasses contained therein to escape to the surrounding environment. A radiant energy source 110 is located outside the processing device 102 and coupled with the transmissive portion 108 of the housing 112. In one embodiment, the radiant energy source 110 is attached to the processing device 102 so as to expose the semiconductor materials/device 106 contained therein to the maximum amount of radiated energy. The radiant energy source 110 may further include a shield or filter (not shown) to direct substantially all of the radiated energy through the transmissive portion 108 of the housing 112 and/or prevent spillage of the excess radiant energy into the surrounding environment where it may present a health, equipment or materials hazard. Further, in embodiments where the processing device 102 includes more than one window (not shown), such for allowing visual observation of the processing therein, non-transmissive windows (not shown), such as ultraviolet filtering windows, operable to prevent the transmission of the radiant energy out of the processing device 102, while still permitting visual observation, may be used to prevent spillage of the radiant energy out of processing device 102. The radiated energy acts to decompose the corrosive gas 104 within the housing 112 into lesser corrosive components. In one embodiment, the radiated energy acts to disassociate the molecules of the corrosive gas into the component radical and/or ions thereof. It will be appreciated that these component radicals and/or ions may quickly reform into lesser corrosive and/or more volatile molecules. For example, HBr breaks down into H* and Br*, HCl breaks down into H* and Cl* and HF breaks down into H* and F*. It will be appreciated that these radicals and/or ions may quickly reform into H₂ and Br₂, Cl₂ or F₂, respectively.

In an alternate embodiment, the radiant energy source 110 may be located within the housing 112, obviating the need for radiated energy transmissive windows 108. In this embodiment, the radiant energy source 110 may shielded, or otherwise protected, from the corrosive gasses 104 within the housing 112.

In one embodiment, the radiant energy source 110 is a light source having an energy/wavelength sufficient to overcome the disassociation energy, i.e. the energy required to separate atoms from one another within a molecule, also called the bond energy, of the corrosive gas molecules. For example, the light source 110 may include an ultraviolet light source. In one embodiment, a UV light source 110 is attached to the processing device 102 in a location where the maximum amount of UV light can be exposed to the semiconductor materials/wafers 106 within the processing device 102. Ultraviolet is defined as the region of the electromagnetic spectrum that is of higher energy and shorter wavelength than visible light. Typical wavelengths of ultraviolet radiation range from 12.5 nanometers (“nm”) to 375 nm. In one embodiment, the wavelengths used to decompose the corrosive gas 104 range from about 100 nm to 265 nm. It will be appreciated that the wavelength used is implementation dependent and may, for example, depend upon the type and mixture of corrosive gases as well as the desired level of resultant decomposition. In one embodiment, the disassociation of hydrogen halides occurs with a quantum yield, i.e. the number of defined events which occur per photon absorbed by the system, of near unity.

In one embodiment, the radiant light source 110 is activated after completion of the semiconductor processing stage and before the semiconductor materials/devices 106 are removed from the processing device 102. In an alternate embodiment, the radiant light source is continuously active, such as active whenever semiconductor materials/devices are present. In another alternative embodiment, the radiant light source 110 is cycled on and off, whenever semiconductor materials/devices 106 are present. In yet another alternative embodiment, sensors (not shown) which may detect the presence of corrosive gasses are used within the housing 112 and coupled with the radiant light source 110 so as to activate the light source 110 when the levels of corrosive gasses exceed a particular threshold and deactivate the light source 110 when the levels drop below the particular threshold.

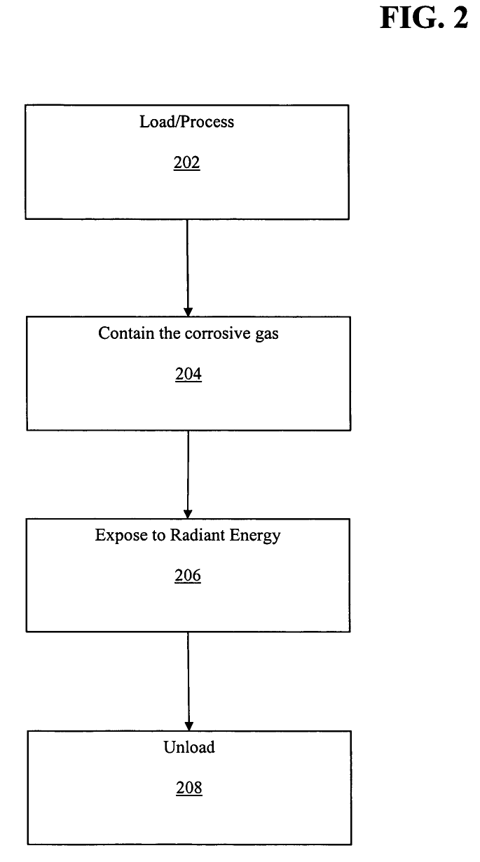

FIG. 2 is a flow chart depicting an exemplary process for reducing corrosive vapors according to the embodiment of FIG. 1. Prior to activating the disclosed corrosive vapor reduction system 100, the semiconductor materials/devices 106 are loaded and/or processed in the processing device 102 (block 202). The processing device 102 may include a semiconductor fabrication device such as a process chamber, a buffer/transfer chamber, a load-lock, or combinations thereof. The processing device 102 is sealed/closed so as to contain the corrosive gasses 104 used in the processing and/or outgassed by the semiconductor materials/devices 106 within the interior housing 112 (block 204) and separate from the surrounding environment. As described above, the corrosive gasses 104 may include inorganic acids, such as hydrogen halides, including Hydrogen Bromide, Hydrogen Chloride, Hydrogen Fluoride, or combinations thereof.

Once processing has completed on the semiconductor materials/devices 106, if necessary, at least a portion of the interior of the housing 112, and thereby the semiconductor materials/devices 106 are exposed to a radiant energy source while the housing is closed (block 206). In one embodiment, the radiant energy source comprises an ultraviolet light source, such as an ultraviolet light source emitting light energy at a wavelength of the energy ranging from about 100 nanometers to 265 nanometers. In one embodiment, the housing 112 includes a window 108 operative to allow radiated energy to pass from an exterior of the housing to the interior while containing the corrosive gas 104 within the interior, wherein the radiant energy source is located proximate to the window on the outside of the housing 112. The window is essentially operative to allow radiated energy to pass from the exterior of the housing to the interior while containing the corrosive gas within the interior. The radiant energy source is further operative to emit sufficient energy to substantially convert the corrosive gas into a lesser corrosive form while the housing is closed, e.g. sufficient energy so as to substantially disassociate the hydrogen halide into at least one component radical, component ion or combinations thereof.

Once the corrosive gasses have been decomposed, the housing 112 may be opened to remove the semiconductor materials/devices 106 and continue the manufacturing process (block 208). In so doing, substantially only the residual lesser corrosive components of the corrosive gasses 104 are exposed to the surround environment and/or equipment.

Accordingly, the disclosed embodiments result in no extra processing steps, no extra equipment and the exposure of/contamination by the corrosive gasses to the atmosphere, equipment and personnel is minimized. The disclosed embodiments may be used with any semiconductor process/device which may utilize corrosive chemicals capable of being broken down by exposure to radiant energy, such as plasma etch, film deposition, or wet chemical processing. This would include, but not be limited to processes such as Deep Trench (“DT”) Etch tools, Gate Conductor (“GC”) Etch Tools, Recess Etch Tools, Metal Etch Tools, Active Area Isolation Trench (“AAIT”) Tools, Hard Mask Open Tools and or Hard Mask Removal Tools, or any other tools or processes where corrosive gasses are introduced.

In practice, a sample prior to UV treatment was shown to have HBr@3.6 parts per million (“ppm”), HF@96 ppm, and HCl@<0.47 ppm. Subsequent to treatment as disclosed, the sample was shown to have HBr@<0.29 ppm, HF@<1.2 ppm and HCl@<0.32. In comparison, an empty chamber has HBr@<0.15 ppm, HF@<0.62 ppm and HCl@<0.16 ppm.

It is therefore intended that the foregoing detailed description be regarded as illustrative rather than limiting, and that it be understood that it is the following claims, including all equivalents, that are intended to define the spirit and scope of this invention.

1-25. (canceled)

26. A system for processing a semiconductor material outgassing a corrosive gas, the system comprising:
a radiant energy source arranged to expose the semiconductor material to energy to decompose the corrosive gas.

27. The system of claim 26, wherein the radiant energy source is adapted to operate in one of a continuous mode to continuously emit the energy to decompose the corrosive gas, and an intermittent mode to intermittently emit the energy to decompose the corrosive gas.

28. The system of claim 26, wherein the corrosive gas comprises an inorganic acid.

29. The system of claim 26, wherein the corrosive gas comprises one of Hydrogen Bromide, Hydrogen Chloride, Hydrogen Fluoride, or combinations thereof.

30. The system of claim 26, wherein the radiant energy source comprises an ultraviolet light source.

31. The system of claim 26, wherein the energy emitted by the radiant energy source ranges from about 100 nanometers to about 265 nanometers.

32. The system of claim 26, further comprising:
a semiconductor processing device having an interior arranged to support the semiconductor material; and
wherein the radiant energy source exposes the interior of the semiconductor processing device to the energy to decompose the corrosive gas.

33. The system of claim 32, wherein the semiconductor processing device comprises a window to allow the energy from the radiant energy source to pass from an exterior of the semiconductor processing device to the interior, the radiant energy source being arranged on the exterior of the semiconductor processing device.

34. The system of claim 32, wherein the radiant energy source is arranged within the interior of the semiconductor processing device.

35. The system of claim 26, further comprising:
a semiconductor processing device having an interior arranged to support the semiconductor material and to receive the corrosive gas for processing the semiconductor material; and
wherein the energy from the radiant energy source decomposes the corrosive gas generated by the outgassing of the semiconductor material and any residual corrosive gas from processing the semiconductor material.

36. The system of claim 35, wherein the semiconductor processing device comprises a window to allow the energy from the radiant energy source to pass from an exterior of the semiconductor processing device to the interior, the radiant energy source being arranged on the exterior of the semiconductor processing device proximate to the window.

37. The system of claim 35, wherein the radiant energy source is arranged within the interior of the semiconductor processing device.

38. The system of claim 35, wherein the radiant energy source is adapted to operate in one of a continuous mode to continuously emit the energy to decompose the corrosive gas, and an intermittent mode to intermittently emit the energy to decompose the corrosive gas.

39. The system of claim 35, further comprising:
a sensor, arranged within the interior of the semiconductor processing device, to detect an amount of the corrosive gas; and
wherein the radiant energy source is activated when the amount of the corrosive gas is greater than a predetermined value.

40. The system of claim 39, wherein the radiant energy source is deactivated when the amount of the corrosive gas is less than the predetermined value.

41. The system of claim 35, wherein the semiconductor processing device comprises one of a process chamber, a buffer/transfer chamber, and a load-lock.

42. A method of reducing outgassing of a corrosive gas from a semiconductor material, comprising:
exposing the semiconductor material to energy from a radiant energy source to decompose the corrosive gas.

43. The method of claim 42, wherein the exposing step comprises:
continuously emitting the energy to decompose the corrosive gas.

44. The method of claim 42, wherein the exposing step comprises:
intermittently emitting the energy to decompose the corrosive gas.

45. The method of claim 42, wherein the semiconductor material is contained in a semiconductor processing device, the method further comprising:
detecting an amount of the corrosive gas in the semiconductor processing device; and
activating the radiant energy source when the amount of the corrosive gas is greater than a predetermined value.

46. The method of claim 45, further comprising:
deactivating the radiant energy source when the amount of the corrosive gas is less than the predetermined value.

47. The method of claim 42, wherein the semiconductor material is contained in an interior of a semiconductor processing device that is adapted to receive the corrosive gas for processing the semiconductor material, and wherein the exposing step further comprises:
exposing the interior of the semiconductor processing device to the energy from the radiant energy source to decompose the corrosive gas supplied to the semiconductor processing device for processing and any residual corrosive gas.

48. The method of claim 47, further comprising:
detecting an amount of the corrosive gas in the semiconductor processing device; and
activating the radiant energy source when the amount of the corrosive gas is greater than a predetermined value.

49. The method of claim 48, further comprising:
deactivating the radiant energy source when the amount of the corrosive gas is less than the predetermined value.

50. The method of claim 42, wherein the corrosive gas comprises an inorganic acid.

51. The method of claim 42, wherein the corrosive gas comprises one of Hydrogen Bromide, Hydrogen Chloride, Hydrogen Fluoride, or combinations thereof.

52. The method of claim 42, wherein the radiant energy source comprises an ultraviolet light source.

53. The method of claim 52, wherein the energy emitted by the radiant energy source ranges from about 100 nanometers to about 265 nanometers.

54. A method of manufacturing a semiconductor material, comprising:
loading the semiconductor material into an interior of a semiconductor processing device;
supplying a corrosive gas into the semiconductor processing device for processing the semiconductor material; and
exposing the semiconductor material and the interior of the semiconductor processing device to energy from a radiant energy source to decompose corrosive gas outgassing from the semiconductor material and any residual corrosive gas from processing the semiconductor material.

55. The method of claim 54, wherein the exposing step comprises:
exposing the semiconductor material and the interior of the semiconductor processing device to continuous emission of the energy from the radiant energy source to decompose the corrosive gas.

56. The method of claim 54, wherein the exposing step comprises:
exposing the semiconductor material and the interior of the semiconductor processing device to intermittent emission of the energy from the radiant energy source to decompose the corrosive gas.

57. A system for processing a semiconductor material outgassing a corrosive gas, comprising:
exposing means for exposing the semiconductor means to energy to decompose the corrosive gas.

58. The system of claim 57, further comprising:
means for supporting the semiconductor material and for receiving the corrosive gas for processing the semiconductor material; and
wherein the energy from the exposing means is to decompose the corrosive gas generated by the outgassing of the semiconductor material and any residual corrosive gas from processing the semiconductor material.

59. A system comprising:
means for containing a corrosive gas in an interior of a semiconductor and;
means for exposing at least a portion of the interior of the semiconductor processing device to a radiant energy source emitting sufficient radiant energy to substantially decompose the corrosive gas.

60. A system comprising:
a semiconductor processing device having an interior in which a corrosive gas is contained; and
a radiant energy source exposed to at least a portion of the interior and capable of emitting sufficient energy to substantially decompose the corrosive gas.
